(19) United States
(12) Patent Application Publication
(10) Pub. No.: US 2014/0351414 A1
(43) Pub. Date: Nov. 27, 2014

(54) Systems And Methods For Providing Prediction-Based Dynamic Monitoring

(71) Applicant: Alcatel Lucent, Paris (FR)

(72) Inventors: Elisha J. Rosensweig, Raanana (IL); Etti Shalev, Hod-Hasharon (IL); Sharon Mendel-Brin, Tel Aviv (IL); Dmitri Krasnenko, Netanya (IL); Vladi Feigin, Even Yehuda (IL); Ifat Afek, Hod-Hasharon (IL)

(73) Assignee: Alcatel Lucent, Paris (FR)

(21) Appl. No.: 13/902,087

(22) Filed: May 24, 2013

(51) Int. Cl. H04L 12/26

(52) U.S. Cl. CPC H04L 43/08
USPC 709/224

(57) ABSTRACT

Dynamic monitoring of an element in a network is provided by predicting whether a resource threshold crossing, such as load-based level, is likely to be exceeded within a certain time period. If the level is likely to be exceeded shortly, the monitoring rate of the element for a given time period may be increased. Conversely, if the level is unlikely to be exceeded in the near term, the monitoring rate may be decreased.

### INTRODUCTION

This section introduces aspects that may be helpful in facilitating a better understanding of the inventions. Statements in this section, however, are not admissions about the content or scope of the prior art.

In some known communications network management solutions various elements making up a communications network may be monitored. For example, a data center within a network may be monitored in order to determine whether the data center is operating correctly or efficiently. In some known solutions, “static” monitoring may be used to monitor hardware servers within the data center. Static monitoring typically involves checking the state of the servers within the data center at regular intervals, using an identical process, across all servers. Static monitoring presents certain disadvantages. For example, static monitoring typically consumes large amounts of the networking, processing, and storage capability of a monitoring system, and of the elements the monitoring system is monitoring (i.e. collectively referred to as “overhead”).

### SUMMARY

The following summary is intended to highlight and introduce aspects of various exemplary embodiments of the invention. Some simplifications may be made. However, such simplifications are not intended to limit the scope of the invention(s).

Exemplary embodiments of systems and methods for providing prediction-based, dynamic monitoring are described herein. According to one embodiment, a method for setting a monitoring rate of an element in a network may comprise: collecting, by a controller, state information associated with an element in a network; determining, by the controller, a time that a resource threshold crossing occurs for the element based on a predictive indication associated with the resource threshold crossing; comparing, by the controller, the determined time to a reference time period for the element; and setting, by the controller, a monitoring rate of the element based on the comparison. The method may further comprise generating, by the controller, the predictive indication based on the collected state information for the element, and setting, by the controller, the monitoring rate for the reference time period. In an embodiment of the invention the network may comprise a cloud-based network, for example.

The method may further comprise: (i) setting, by the controller, the rate to a first monitoring rate for the reference time period of the element based on a determination that the determined time is within the reference time period for the element; (ii) setting, by the controller, the rate to a second frequent monitoring rate for the reference time period of the element (e.g., less frequent monitoring rate) based on a determination that the determined time is not within the reference time period for the element; (iii) setting, by the controller, the rate to a selected rate in between the first monitoring rate and the second monitoring rate for the reference time period of the element based on a determination that the determined time is not within the reference time period of the element; or (iv) setting, by the controller, the rate to a selected rate in between the first frequent monitoring rate and the second monitoring rate for the reference time period of the element based on a determination that the determined time is within the reference time period of the element.

In embodiments of the invention, the resource threshold crossing may be selected from among the group consisting of at least a load-based threshold crossing, an error-based threshold crossing and a power-based threshold crossing, for example.

Yet further, a method may additionally comprise generating, by the controller, the predictive indication by: (i) applying a multi-dimensional, regression analysis process to the collected state information (e.g., linear regression process), or (ii) applying a Bayesian analysis process to the collected state information, to name two examples of processes that may be applied to the collected state information.

The collected state information may comprise recent and past information concerning the operation of each element in the network, or information from outside of the network, for example, and may be selected from among the group consisting of at least load-based information, error-based information and power-based information, for example.

In addition to the exemplary methods described above, the present invention is also directed at a system or systems for setting a monitoring rate of an element of a network. In one exemplary system, a controller may be operable to: collect state information associated with an element in a network; determine a time that a resource threshold crossing occurs for the element based on a predictive indication associated with the resource threshold crossing; compare the determined time to a reference time period for the element; and set a monitoring rate of the element based on the comparison. The controller maybe further operable to generate the predictive indication based on the collected state information for the element, and to set the monitoring rate for the reference time period. In an embodiment of the invention the network may comprise a cloud-based network, for example.

In one embodiment of the invention the system may additionally comprise at least one network element, where the element may comprise or more data center servers, for example.

Similar to the methods described above, in embodiments of the invention the controller of such a system may be operable to set the monitoring rate to: (i) a first monitoring rate for the reference time period of the element based on a determination that the determined time is within the reference time period of the element; (ii) set the rate to a second monitoring rate for the reference time period of the element based on a determination that the determined time is not within the reference time period of the element (e.g., less frequent monitoring rate); (iii) set the rate to a selected rate in between the first monitoring rate and the second monitoring rate for the reference time period of the element based on a determination that the determined time is not within the reference time period of the element; or (iv) set the rate to a selected rate in between the first monitoring rate and the second monitoring rate for the reference time period of the element based on a determination that the determined time is within the reference time period of the element.

Further, the resource threshold crossing may be selected from among the group consisting of at least a load-based threshold crossing, an error-based threshold crossing and a power-based threshold crossing, for example.

Regarding the generation of the predictive indication(s), the controller may be yet further operable to generate the predictive indication by applying a multi-dimensional regression analysis process to the collected state information (e.g. linear regression process), or a Bayesian analysis process to the collected state information, for example.

The collected state information may comprise recent and past information concerning the operation of the element in the network, or information from outside of the network, and may be selected from among the group consisting of at least load-based information, error-based information and power-based information, for example.

The description above summarizes some of the possible embodiments of the invention where the monitoring rate of elements of the cloud may be changed rapidly, dynamically. Additional embodiments of the invention will be apparent from the following detailed description and appended drawings.

### BRIEF DESCRIPTION OF THE DRAWINGS

FIG. 1 depicts an exemplary block diagram of a monitoring system according to an embodiment of the invention.

FIG. 2 depicts another exemplary block diagram of a monitoring system according to another embodiment of the invention.

FIG. 3 depicts a flow diagram of a method in accordance with an embodiment of the invention.

### DETAILED DESCRIPTION, INCLUDING EXAMPLES

Exemplary embodiments of systems and related methods for providing prediction-based, dynamic monitoring are described herein in detail, and shown by way of example in the drawings. Throughout the following description and drawings, like reference numbers/characters refer to like elements.

It should be understood that, although specific exemplary embodiments are discussed herein there is no intent to limit the scope of present invention to such embodiments. To the contrary, it should be understood that the exemplary embodiments discussed herein are for illustrative purposes, and that modified and alternative embodiments may be implemented without departing from the scope of the present invention.

It should be noted that some exemplary embodiments may be described as processes or methods depicted in a flow diagram. Although the flow diagram may describe the processes/methods as sequential, the processes/methods may be performed in parallel, concurrently or simultaneously. In addition, the order of each step within a process/method may be re-arranged. A process/method may be terminated when completed, and may also include additional steps not included in the flow diagram. The processes/methods may correspond to functions, procedures, subroutines, subprograms, etc., completed by a system and/or system component.

As used herein, the term “and/or” includes any and all combinations of one or more of the associated listed items. It should be understood that if a component is referred to, or depicted, as being connected to another component it may be directly connected to the other component or intervening components may be present, unless otherwise specified. As used herein, the singular forms “a,” “an” and “the” are not intended to include the plural form, unless the context indicates otherwise.

Unless specifically stated otherwise, or as is apparent from the discussion, the terms “determining”, “collecting”, “generating”, “comparing”, “setting” and the like refer to the functions and processes of a computing device or system. Such a computing device or system may be part of another device/system, such as a hardware controller or server, or similar electronic computing device, and may be operable to manipulate and transform data represented as physical, electronic quantities within the computing system's registers, memories, other information storage, transmission or display devices and other computer readable mediums (collectively “memory” or “memories” for short), for example, into other data similarly represented as physical quantities within the computing system's memories. Relatedly, the term “controller” includes one or more processors that are operable to access and execute (collectively “execute”) instructions stored in one or more memories in order to complete functions, processes and features of the present invention. Unless specifically stated otherwise, or as is apparent from the discussion, the phrase “operable to” means at least: having the capability of operating to complete, or is operating to complete, specified features, functions, process steps; or having the capability to meet desired characteristics, or meeting desired characteristics.

As used herein, the term “embodiment” refers to—an embodiment of the present invention—.

Various embodiments provide a method and apparatus for providing prediction-based, dynamic monitoring of an element in a network. In particular, dynamic monitoring predicts whether a resource threshold crossing, such as a load-based level, is likely to be exceeded within a certain time period. If the level is likely to be exceeded shortly, the monitoring rate of the element for a given time period may be increased. Conversely, if the level is unlikely to be exceeded in the near term, the monitoring rate may be decreased. Advantageously, by providing prediction-based dynamic monitoring, the amount of overhead required to monitor elements of a network may be reduced without compromising the quality of the monitoring services provided. Moreover, the manner in which elements of a cloud-based network are monitored may be improved without exceeding overhead capabilities.

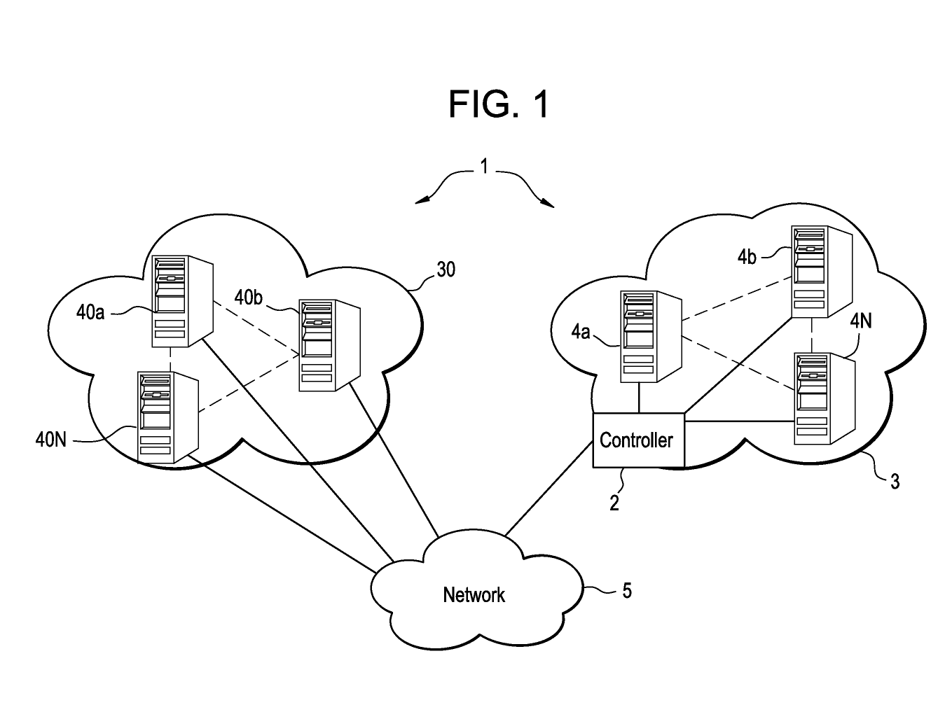

FIG. 1 depicts an exemplary block diagram of a dynamic monitoring system 1 according to one embodiment of the invention. For example, the system 1 may comprise a cloud-based system though that is only one example of the type of system provided by the present invention. System 1 may comprise a controller 2 that may be operable to monitor one or more elements of a cloud-based network 3, for example, though that is only one example of the type of network that may include the inventive systems and their related methods. In more detail, the inventive systems and their related methods described herein may be applied to a network that requires anomaly detection. Said another way, the inventive systems and related methods may be applied to a network that includes a number of elements where it is important to monitor the operation of one or more of these elements to insure they are operating correctly or efficiently. To do so, anomalies may be detected by the inventive systems and related methods. Such anomalies may be compared to thresholds in order to inform a network operator and/or end user customer or client (via an alarm or notification of some kind) and allow such operator or client to take corrective action, if necessary.

In an embodiment of the invention, the network 3 may comprise a data center or the like which may comprise one or more elements 4a, b, . . . n, such as data center servers (where “n” indicates the last element or server). The cloud-based network 3 may be connected (and typically is connected) to a large network 5, such as the Internet or another data or communications network that may include additional networks, such as cloud-based network 30 and servers 40a, 40b, . . . 40n.

In the example shown in FIG. 1, the controller 2 is depicted as a single hardware component. However, it should be understood that the controller 2 may be implemented as a plurality of hardware devices, such as controllers or servers, for example. In one embodiment, each of the plurality of devices making up the controller 2 may be co-located (or located at the same location). In an alternative embodiment, each of the devices making up the controller 2 may be distributed or located at different locations.

To monitor the network 3, and in particular the elements/servers 4a, b, . . . n, the inventors developed a novel analytics module which may be a part of one or more controllers, such as controller 2, for example. In some embodiments, the analytics module may comprise a processor or processors that are operable to execute instructions stored in associated memory for completing complex processes, functions and features used to analyze data (e.g., “state information”, discussed below) received from the network 3, and to further analyze the behavior and operation of the network 3 and elements 4a, b, . . . n. For example, in one embodiment the analytics module may generate predictions on the state of a given element, such as element 4a. One type of prediction may provide a reasonable indication (i.e., a prediction with high probability) of when element 4a (or the group of elements/servers 4a, b, . . . n) may pass a particular threshold crossing (i.e., a level or value). In an embodiment, the analytics module may include a statistical analysis capability, such as a multi-dimensional regression analysis for example, that analyzes the operation and behavior of the network 3 and its elements/servers 4a, b, . . . n over the recent and less-recent past, for example.

Before continuing it should be noted that the term “element” is not limited to a single server. For ease of explanation we will assign the phrase “element” the meaning of a single server. However, the present invention is applicable to an element that includes multiple servers. Said another way, in an alternative embodiment the network 3 may be considered a single element as well. Yet further, the term element may include one or more virtual machines (VM) that are implemented on one or more servers, controllers or another type of electronic hardware device, for example.

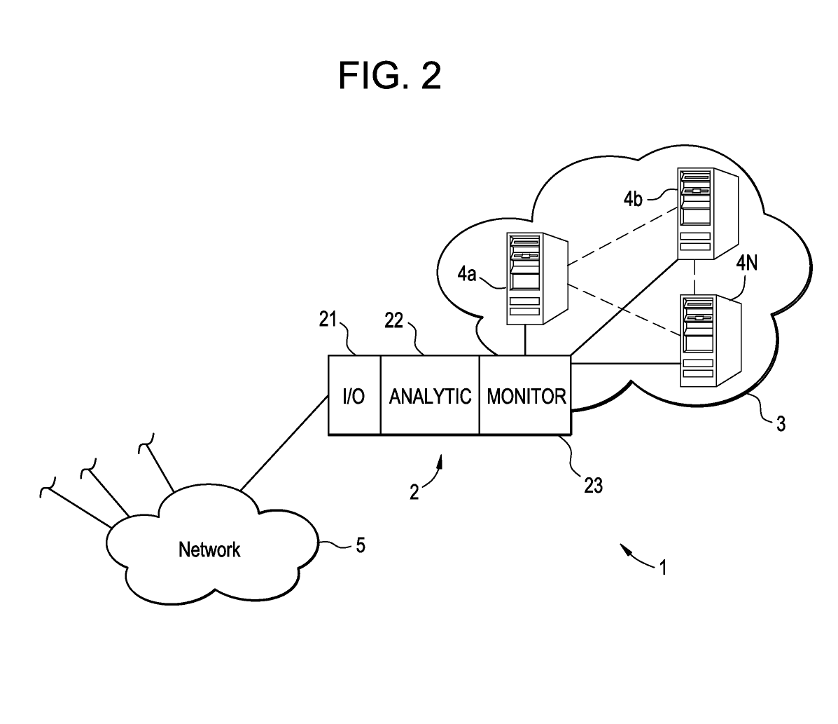

Referring to FIG. 2, there is depicted another exemplary block diagram of the dynamic, cloud-based monitoring system 1 according to an embodiment. As depicted, the controller 2 may include an analytics module 22 or some portion of such a module and a monitoring module 23 or some portion of such a module. That is, the controller 2 may include both modules or may include portions of each module in the case where functions and features of one or both modules 22, 23 may be completed by more than one controller. For ease of understanding we will focus on the capabilities of a single analytics module 22 and a single monitoring module 23 within a single controller 2, it being understood that the capabilities of the modules may be completed by a combination of an analytics and monitoring module present on a single controller, or on multiple controllers, or by separate analytics and monitoring modules present on a single controller or multiple controllers, for example. As was the case for the analytics module 22, the monitoring module 23 may comprise a processor or processors that are operable to execute instructions stored in associated memory for completing certain processes, functions and features described herein, for example.

In an embodiment of the invention, the controller 2 may be operable to set or select one or more reference time periods or “windows” for each element/server 4a, b, . . . n. The time periods may be input into the analytics module 22 by the cloud provider that operates the system 1, or as a part of a process executed by an analytics module 22, for example. Further, the controller 2 may be operable to define and set or select a monitoring rate or rates. This rate or rates may be input by a cloud provider that operates the system 1 or as a part of a process executed by an analytics module 22 or monitoring module 23, for example.

For example, two rates may be set. A “first” rate may be a higher monitoring rate than a “second” rate, for example. For ease of explanation herein the first rate may be referred to as a “frequent monitoring” rate or “frequent” rate while the second, lower rate may be referred to as a “less frequent monitoring rate” or “less frequent” rate. Alternatively, one or more rates that are in between a frequent monitoring rate and a less frequent monitoring rate may be defined and set/selected.

It should be understood that the controller 2 may also include all of the necessary electronic components needed to receive signals and data from the network 5 or the data servers 4a, 4b, . . . 4n, as well as transport signals and data to and from the analytics module 22 and monitoring module 23. Such circuitry may include, but is not limited to, input/output (I/O) circuitry 21.

In an embodiment, the monitoring module 23 may be operable to collect state information (e.g., load) for each element 4a, 4b, . . . 4n in the cloud-based network 3, and then transmit or otherwise send that collected information to the analytics module 22. For each element 4a, 4b, . . . 4n, the analytics module 22 may be operable to generate predictions regarding when a resource threshold crossing (i.e., a level or value) may be exceeded, for example. In an embodiment of the invention, for each element 4a, 4b, . . . 4n a threshold crossing may be predicted to occur at a certain time. In an embodiment, if the predicted time is determined to fall within a reference time period for a given element/server 4a, b, . . . n then a monitoring rate for that given element/server 4a, b, n and reference time period may be set to a first or frequent rate. Otherwise the monitoring rate may be set to a second or less frequent rate. Alternatively, one or more rates may be set that are in between a frequent monitoring rate and a less frequent monitoring rate.

In an embodiment of the invention this process may be repeated continuously, as long as an element/server 4a, b, n is operational, for example.

In more detail, the controller 2 may be operable to collect state information for each element 4a, b, . . . n in the cloud-based network 3 (using a monitoring module 23 for example), generate a predictive indication associated with a resource threshold crossing based on the collected information for each element 4a, b, . . . n in the cloud-based network 3 (using the analytics module 22, for example). Thereafter, the controller 2 may be further operable to determine a time that the resource threshold crossing occurs (e.g., when a load level or value is exceeded) for each element 4a, b, . . . n based on the predictive indication, and compare the determined time to a reference time period for each element (using the analytics module 22, for example). This comparison may be completed in order to determine, for example, how soon (time-wise) a threshold level may be crossed. Upon completing this comparison the controller 2 may be operable to set a monitoring rate for a given time period associated with each element 4a, b, . . . n based on the comparison using an analytics module 22, for example.

In one embodiment the controller 2 may be operable to set the reference time period or window to a period between 30 minutes and 90 minutes (e.g., 60 minutes), for example. In alternative embodiments of the invention a reference time period may comprise a maximum or minimum time period. Still further, in additional embodiments the reference time period may be set based on how reliable the system 1 (e.g., controller 2) predicts the occurrence of when a threshold crossing may be exceeded. For example, the more reliable a prediction, the smaller the reference time period or window, and conversely, the less reliable a prediction the larger the reference time period.

Further, the controller 2 may be operable to set the rate to a frequent monitoring rate (e.g., collecting state information every minute) for a given element 4a, b, . . . n based on a determination that the determined time is within a reference time period of the given element 4a, b, . . . n. Said another way, if the comparison indicates that a threshold crossing may occur shortly, and, therefore, is within a reference time period for a given element, then the rate may be set to a frequent monitoring rate.

Conversely, if the comparison indicates that a threshold crossing is unlikely to occur anytime soon, and, therefore, is not within a reference time period of a given element, then the rate for a given element may be set to a less frequent monitoring rate. More particularly, in an alternative embodiment of the invention, the controller 2 may be further operable to set the monitoring rate to a less frequent monitoring rate (e.g., collecting state information every 5 minutes) for an element 4a, b, . . . n based on a determination that the determined time is not within a reference time period of a given element. It should be noted that the 1 minute and 5 minute time periods are for exemplary purposes only, and that other higher or lesser rates may be used in order to detect network anomalies (e.g., threshold crossings).

In some embodiments, the rate may be set to more than two values. In some of these embodiments, one or more rates between a frequent monitoring rate and a less frequent monitoring rate may be selected and set (e.g., between 1 minute and 5 minutes). In particular, the controller 2 may be further operable to select and set a rate or rates between a less frequent monitoring rate and a frequent monitoring rate for a reference time period of an element 4a, b, . . . n based on a determination that: (i) a determined time is not within a reference time period of a given element 4a, b, . . . n; or (ii) that a determined time is within a reference time period of an element 4a, b, . . . n.

In an embodiment, the state information that may be collected may comprise recent and past information concerning the operation of each element 4a, b, . . . n in the network 3, for example. In the example above, the state information that was collected relates to the load on a given element or elements 4a, b, . . . n. It should be understood that this is just one of the many types of state information that may be collected. Similarly, the type of resource threshold crossing is not limited to a load-based threshold crossing. In an embodiment, the state information that may be collected may be selected from among the group consisting of at least load-based information, error-based information, and power-based information while the resource threshold crossing may be selected from among the group consisting of at least a load-based threshold crossing, an error-based threshold crossing and a power-based threshold crossing, to name just a few examples. In addition, the type of state information need not originate from within the network 3. That is, information from outside of network 3 may be collected and used to determine a monitoring rate. Some examples of the type of information that may be collected outside of the network 3 are weather-related information, calendar-related information and location-related information.

The analytics module 22 has been described as including a statistical analysis capability, such as a regression analysis for example, for analyzing the operation and behavior of the network 3, and its elements/servers 4a, b, . . . n. In particular, the controller 2 may be further operable to generate the predictive indication(s) by applying a multi-dimensional regression analysis to collected state information.

For example, in an embodiment, the analytics module 22 may execute instructions stored in memory to complete a linear regression process to generate predictions based on collected state information.

In more detail, the collected state information may be formed as a sequence of multi-dimensional vectors, where each vector may represent the state of an associated element (or elements) at some point in time. The variables in the vector may be a representation of this state. For example, a vector (2,5,6) may represent a state where an element has been allotted 2 processing or CPU units, 5 gigabits of storage and 6 megabits of memory, for example. Each such vector may be associated with a particular time, t. In an embodiment, the analytics module 22 may be operable to execute instructions stored in memory to determine the linear function f(t)=at+b to minimize the squared distance of f(t) from associated, collected data points (state information) using a “least-squares” process, for example. Note that the parameters a,b may represent unknowns, and are vectors of the same length as the data vectors. Next, the module 22 may be further operable to predict a state of a given element in the future. For example, given data (state information) for times t=0, 1, 2, 3, . . . , 10, the module 22 may be operable to compute a state (e.g., load) associated with t=100 by inserting 100 into f(t). Such a state may comprise a prediction of the state of the element at time t=100, for example. Thereafter, the module 22 may be operable to compare the predicted state to a threshold crossing (e.g., level or value) in order to, thereafter, set a monitoring rate for a particular reference time period.

In alternative embodiments, analytics modules may execute instructions stored in memory to apply alternative multi-dimensional regression analyses (e.g., f(t)=at²+bt+c that is a “higher” dimensional analysis than linear regression), or non-regression type prediction processes, such as Bayesian-based prediction processes, to collected state information. In a Bayesian-based prediction process the analytics module 22 may be operable to execute instructions stored in memory to associate a distribution class (e.g., exponential, normal, bi-normal) related to server loads, for example, with resource behavior (i.e., behavior of an element, such as a server 4a, 4b, . . . 4n, for example). In more detail, the state information collected by the monitoring module 23, for example, may be sent to the analytics module 22 which may be operable to fine-tune parameters of a resource's present behavior, compute a distribution and then generate a high precision prediction of the future behavior of a resource's behavior, for example.

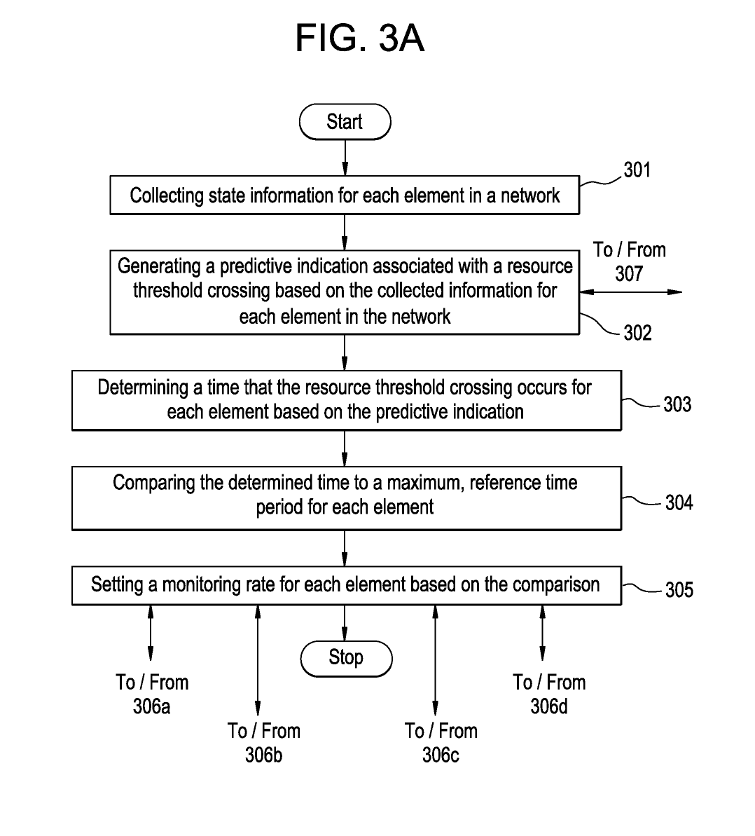

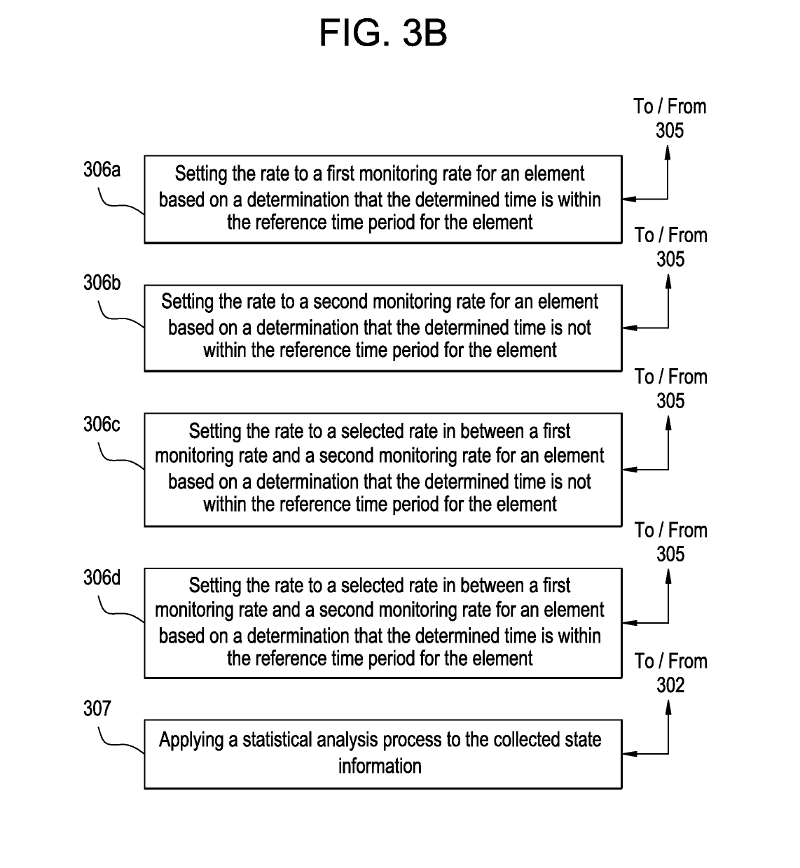

FIG. 3 depicts a flow diagram illustrating an exemplary method for providing prediction-based dynamic monitoring of an element or elements in a network. In accordance with an embodiment, the method may comprise collecting state information, by a controller (for example) for each element in a network, in step 301, generating, by the controller (for example), a predictive indication associated with a resource threshold crossing based on the collected information for each element in the network, in step 302, determining, by the controller (for example), a time that the resource threshold crossing occurs for each element based on the predictive indication, in step 303, comparing, by a controller (for example), the determined time to a reference time period for each element using the controller, in step 304, and setting, by the controller (for example), a monitoring rate for the reference time period of each element based on the comparison, in step 305.

In addition, such a method may comprise setting, by the controller (for example), a rate to: a first monitoring rate for an element based on a determination that the determined time is within the reference time period of the element, in step 306a; or setting, by the controller (for example), the rate to a second monitoring rate for an element based on a determination that the determined time is not within a reference time period for the element, in step 306b; or setting, by the controller (for example), the rate to a selected rate in between the first and second monitoring rates for an element based on a determination that the determined time is not within a reference time period of the element, in step 306c; or setting, by the controller (for example), the rate to a selected rate in between a first and second monitoring rate for an element based on a determination that the determined time is within a reference time period for the element, in step 306d, for example.

In an embodiment, the generation, by the controller (for example), of the predictive indication may comprise applying a multi-dimensional regression analysis process (e.g., linear regression or higher dimensional processes), a Bayesian-based prediction process, or another statistical analysis process to the collected state information, in step 307, for example.

While exemplary embodiments have been shown and described herein, it should be understood that variations of the disclosed embodiments may be made without departing from the spirit and scope of the invention. For example, related methods that provide similar operating results using similar components may be within the scope of the present invention. That said, the scope of the invention should be determined based on the claims that follow.

We claim:

1. A method for setting a monitoring rate of an element in a network comprising:
collecting, by a controller, state information associated with an element in a network;
determining, by the controller, a time that a resource threshold crossing occurs for the element based on a predictive indication associated with the resource threshold crossing;
comparing, by the controller, the determined time to a reference time period for the element; and
setting, by the controller, a monitoring rate of the element based on the comparison.

2. The method as in claim 1 further comprising generating, by the controller, the predictive indication based on the collected state information for the element.

3. The method as in claim 1 further comprising setting, by the controller, the monitoring rate for the reference time period.

4. The method as in claim 1 wherein the network comprises a cloud-based network.

5. The method as in claim 1 further comprising setting, by the controller, the rate to a first monitoring rate based on a determination that the determined time is within the reference time period.

6. The method as in claim 1 further comprising setting, by the controller, the rate to a second monitoring rate based on a determination that the determined time is not within the reference time period.

7. The method as in claim 1 further comprising setting, by the controller, the rate to a selected rate in between a first monitoring rate and a second monitoring rate based on a determination that the determined time is not within the reference time period.

8. The method as in claim 1 further comprising setting, by the controller, the rate to a selected rate in between a first monitoring rate and a second monitoring rate based on a determination that the determined time is within the reference time period.

9. The method as in claim 1 wherein the resource threshold crossing is selected from among the group consisting of at least a load-based threshold crossing, an error-based threshold crossing and a power-based threshold crossing.

10. The method as in claim 2 wherein the generation, by the controller, of the predictive indication comprises applying a multi-dimensional, regression analysis process to the collected state information.

11. The method as in claim 1 wherein the generation, by the controller, of the predictive indication comprises applying a Bayesian analysis process to the collected state information.

12. The method as in claim 1 wherein the collected state information comprises recent and past information concerning the operation of each element in the network.

13. The method as in claim 1 wherein the collected state information comprises information from outside of the network.

14. The method as in claim 1 wherein the collected state information comprises state information selected from among the group consisting of at least load-based information, error-based information and power-based information.

15. A system for setting a monitoring rate of an element of a network comprising:
a controller operable to,
collect state information associated with an element in a network;
determine a time that a resource threshold crossing occurs for the element based on a predictive indication associated with the resource threshold crossing;
compare the determined time to a reference time period for the element; and
set a monitoring rate of the element based on the comparison.

16. The system as in claim 15 wherein the controller is further operable to generate the predictive indication based on the collected state information for the element.

17. The system as in claim 15 wherein the controller is further operable to set the monitoring rate for the reference time period.

18. The system as in claim 15 wherein the network comprises a cloud-based network.

19. The system as in claim 15 wherein the element comprises one or more data center servers.

20. The system as in claim 15 wherein the controller is further operable to set the rate to a first monitoring rate of the element based on a determination that the determined time is within the reference time period.

21. The system as in claim 15 wherein the controller is further operable to set the rate to a second monitoring rate of the element based on a determination that the determined time is not within the reference time period.

22. The system as in claim 15 wherein the controller is further operable to set the rate to a selected rate in between a first monitoring rate and a second monitoring rate of the element based on a determination that the determined time is not within the reference time period.

23. The system as in claim 15 wherein the controller is further operable to set the rate to a selected rate in between a first monitoring rate and a second monitoring rate of the element based on a determination that the determined time is within the reference time period.

24. The system as in claim 15 wherein the resource threshold crossing is selected from among the group consisting of at least a load-based threshold crossing, an error-based threshold crossing and a power-based threshold crossing.

25. The system as in claim 16 wherein the controller is further operable to generate the predictive indication by applying a multi-dimensional regression analysis process to the collected state information.

26. The system as in claim 16 wherein the controller is further operable to generate the predictive indication by applying a Bayesian analysis process to the collected state information.

27. The system as in claim 15 wherein the collected state information comprises recent and past information concerning the operation of the element in the network.

28. The system as in claim 15 wherein the collected state information comprises information from outside of the network.

29. The system as in claim 15 wherein the collected state information comprises state information selected from among the group consisting of at least load-based information, error-based information and power-based information.

30. The system as in claim 15 further comprising at least one element in a cloud-based network, the element comprising one or more data center servers.
